(19) United States
(12) Patent Application Publication
(10) Pub. No.: US 2017/0083114 A1
(43) Pub. Date: Mar. 23, 2017

(54) ELECTRONIC APPARATUS AND METHOD

(71) Applicant: Kabushiki Kaisha Toshiba, Tokyo (JP)

(72) Inventor: Satoshi Takezaki, Ome Tokyo (JP)

(21) Appl. No.: 15/266,839

(22) Filed: Sep. 15, 2016

Related U.S. Application Data
(60) Provisional application No. 62/220,720, filed on Sep. 18, 2015.

(51) Int. Cl. G06F 3/0346; G06F 3/01

(52) U.S. Cl. CPC G06F 3/0346; G06F 3/011; G06F 3/017

(57) ABSTRACT

According to one embodiment, an electronic apparatus includes a camera configured to capture an image, a hardware processor connected to the camera and a display configured to display a cursor in a screen. The hardware processor is configured to acquire the image captured by the camera, the image including user's one hand and an object different from the user's one hand, detect movement of the object on the user's one hand in the acquired image, and move the cursor in response to the detected movement.

### CROSS-REFERENCE TO RELATED APPLICATIONS

This application claims the benefit of U.S. Provisional Application No. 62/220,720, filed Sep. 18, 2015, the entire contents of which are incorporated herein by reference.

### FIELD

Embodiments described herein relate generally to an electronic apparatus and a method.

### BACKGROUND

Recently, electronic apparatuses called wearable devices, which can be worn and used by the user, have been developed.

Various forms of such wearable devices have been developed, and a wearable device mounted on the user's head and used is well known as, an eyeglasses-type wearable device.

Such an eyeglasses-type wearable device includes a processor such as a CPU. Various types of software including, for example, an operating system (OS) can be executed on the eyeglasses-type wearable device.

It is assumed here that the OS based on an input operation using, for example, a mouse or a touchpad is executed on the eyeglasses-type wearable device. In this case, accepting an operation equal to the input operation on the eyeglasses-type wearable device (i.e., executing the operation for the device) is difficult, and an input error may occur.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an illustration for explaining an example of an appearance of an electronic apparatus of an embodiment.

FIG. 2 is an illustration showing a status in which a user wears the electronic apparatus.

FIG. 3 is an illustration showing an example of the electronic apparatus body attachable to or detachable from eyeglasses.

FIG. 4 is a block diagram showing an example of a system configuration of the electronic apparatus.

FIG. 5 is a block diagram showing an example of a functional configuration of the electronic apparatus.

FIG. 6 is a flowchart showing an example of a processing procedure of the electronic apparatus.

FIG. 7 is an illustration showing an example of a movement of the user on accepting an operation.

FIG. 8 is an illustration showing another example of a movement of the user on accepting an operation.

FIG. 9 is an illustration showing yet another example of a movement of the user on accepting an operation.

### DETAILED DESCRIPTION

Various embodiments will be described hereinafter with reference to the accompanying drawings.

In general, according to one embodiment, an electronic apparatus includes a camera configured to capture an image, a hardware processor connected to the camera and a display configured to display a cursor in a screen. The hardware processor is configured to acquire the image captured by the camera, the image including user's one hand and an object different from the user's one hand, detect movement of the object on the user's one hand in the acquired image, and move the cursor in response to the detected movement.

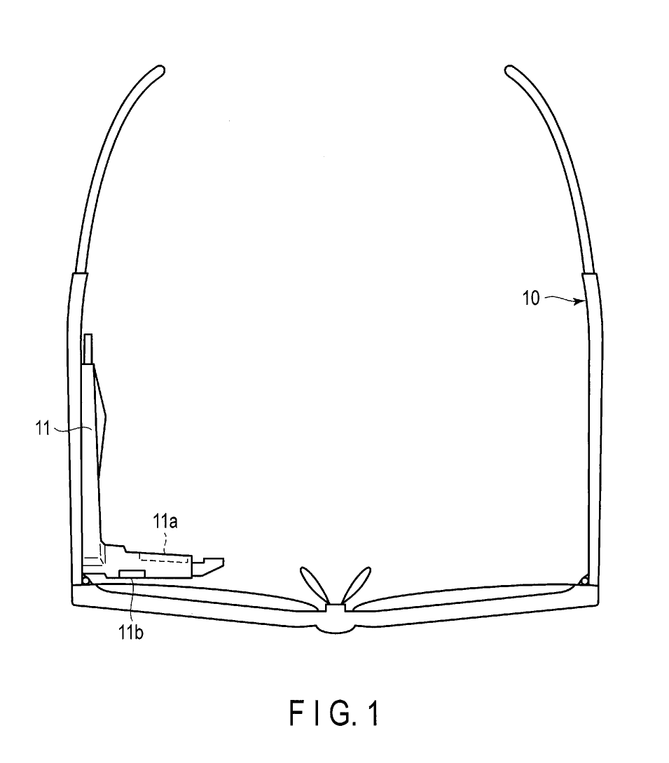

First, an appearance of the electronic apparatus of the embodiment will be explained with reference to FIG. 1. The electronic apparatus is, for example, a wearable device (head-mounted display) mounted on the user's head. FIG. 1 illustrates an example of implementing the electronic apparatus as an eyeglasses-shaped wearable device (hereinafter explained as an eyeglasses-type wearable device). The electronic apparatus of the present embodiment is implemented as the eyeglasses-type wearable device in the following explanations.

Of a frame of an eyeglasses shape of the electronic apparatus, a portion supporting the lens is called a front (portion) and a portion including an earmuff other than the front portion is called a temple (portion).

As shown in FIG. 1, an electronic apparatus (eyeglasses-type wearable device) 10 includes an electronic apparatus body 11 elongated along the front portion (a right lens portion of the eyeglasses shape) from the temple portion located on a user's right side if the electronic apparatus 10 is worn. The electronic apparatus 10 may include the electronic apparatus body 11 elongated along the front portion from the temple portion located on a user's left side if the electronic apparatus 10 is worn.

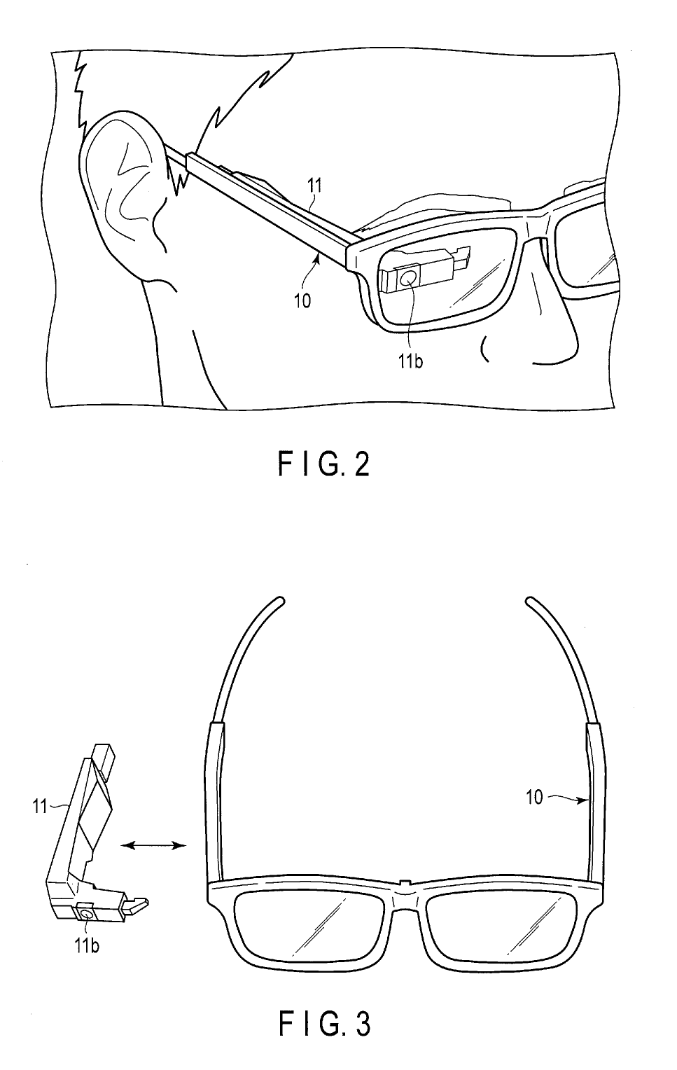

A display 11a and a camera 11b are built into the electronic apparatus body 11. The display 11a is, for example, a small monitor or the like and displays a screen or the like including various types of information supplied to the user. It is assumed that the display 11a is provided at a position so that the user can visually recognize when the user wears the electronic apparatus 10 as shown in FIG. 2.

The camera 11b is a imaging device capable of capturing images such as a still image, a moving image and the like. The camera 11b can capture an image of an object existing in a direction of the line of sight of the user when wearing the electronic apparatus 10 since the camera 11b is provided at the position shown in FIG. 1 and FIG. 2.

The glasses and the electronic apparatus body 11 are integrated in the electronic apparatus 10 in FIG. 1, but the electronic apparatus body 11 may be designed to be attachable to or detachable from general-purpose glasses as shown in FIG. 3.

In addition, for example, the electronic apparatus body 11 includes a power button or the like for turning on the power of the electronic apparatus 10, which is not shown in FIG. 1 or the like.

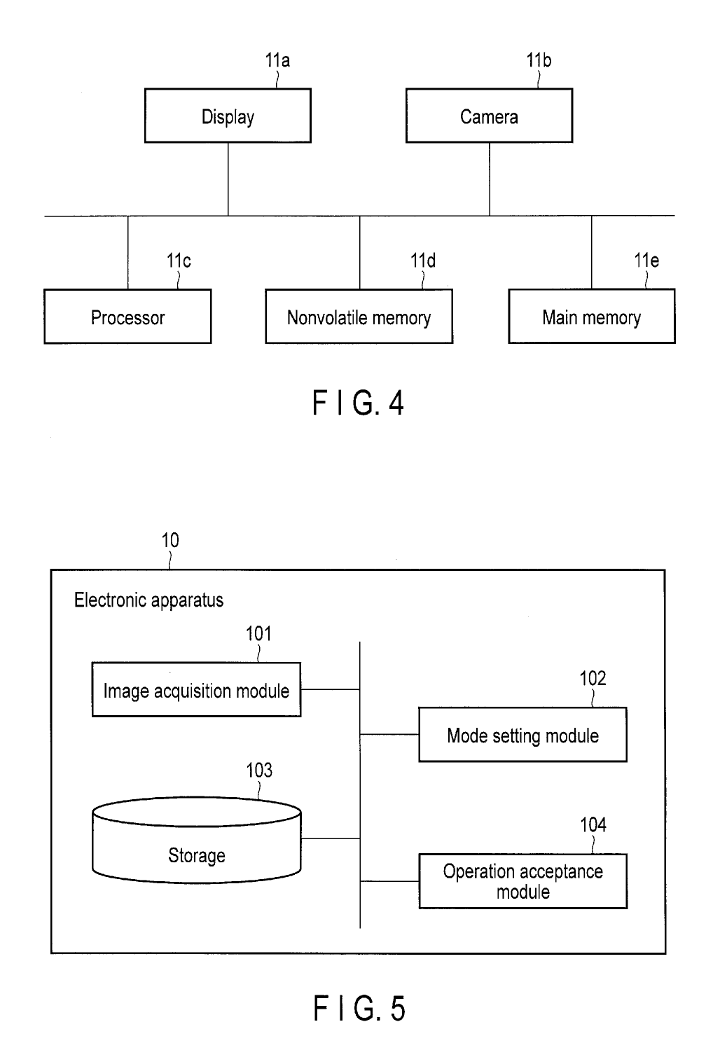

FIG. 4 shows an example of a system configuration of the electronic apparatus 10. As shown in FIG. 4, the electronic apparatus 10 includes a processor 11c, a nonvolatile memory 11d and a main memory 11e in addition to the display 11a and the camera 11b explained with reference to FIG. 1 and the like, and they are connected by interconnects on a substrate and buses.

The processor 11c, the nonvolatile memory 11d and the main memory 11e are assumed to be built into a housing of the electronic apparatus body 11.

The processor 11c is a hardware processor which controls operations of various components in the electronic apparatus 10. The processor 11c executes various types of software loaded from the nonvolatile memory 106 serving as a storage device, to the main memory 11e. The processor 11c includes, for example, a processing circuit such as a CPU or a GPU. In addition, the software executed by the processor 11c includes, for example, an operating system (OS), a program for accepting an operation to the electronic apparatus 10 (hereinafter referred to as an operation acceptance program), and the like.

The processor 11c, the nonvolatile memory 11d and the main memory 11e may be built into the outside of the electronic apparatus body 11, for example, a frame portion of the electronic apparatus 10 or the like.

It is considered that, for example, a simple hand gesture or the like is made if the user operates the above-explained eyeglasses-type wearable device. However, if the OS based on an operation (input operation) using, for example, a mouse or a touchpad (touchpanel) is executed on the electronic apparatus 10, executing the operation for designating a fine position or the like by using the mouse or the touchpad (hereinafter referred to as a position input operation) by the hand gesture is difficult. Furthermore, discriminating the position input operation and an operation corresponding to a click operation on the mouse or a tap operation on the touchpad (hereinafter referred to as a decision input operation) is also difficult.

Thus, the present embodiment provides a function enable the position input operation, the decision input operation, and the like to be distinguished and accepted with a high accuracy (hereinafter referred to as an operation acceptance function).

FIG. 5 is a block diagram showing a functional configuration of the electronic apparatus 10 of the present embodiment. A functional module on the operation acceptance function will be mainly explained with reference to FIG. 5.

As shown in FIG. 5, the electronic apparatus 10 includes an image acquisition module 101, a mode setting module 102, a storage 103 and an operation acceptance module 104.

In the present embodiment, some or all the image acquisition module 101, the mode setting module 102, and the operation acceptance module 104 are assumed to be implemented by urging the processor 11c to execute the operation acceptance program, i.e., by software. Some or all the modules 101, 102 and 104 may be implemented by hardware such as an exclusive chip or the like or implemented as a combined configuration of exclusive hardware and software executed by a general-purpose. In these cases, the hardware such as an exclusive chip or the combined configuration is connected to the camera 11b and the display 11a. In addition, in the present embodiment, the storage 103 is assumed to be stored in the nonvolatile memory 11d.

The image acquisition module 101 acquires an image captured by the camera 11b. The image acquisition module 101 sequentially acquires images (frames) in accordance with, for example, a frame rate (number of frames which can be processed in a unit time in a moving image) set in the camera 11b.

The mode setting module 102 analyzes the image acquired by the image acquisition module 101 and detects an object in the image. If the mode setting module 102 detects a predetermined object (hereinafter referred to as a first object) in the image acquired by the image acquisition module 101, the mode setting module 102 sets the electronic apparatus 10 in a mode for accepting the operation on the electronic apparatus 10 (hereinafter referred to as an operation acceptance mode).

In the storage 103, for example, an object pattern defining various information on the object (for example, a shape of the object and the like) is preliminarily stored.

Similarly to the mode setting module 102, the operation acceptance module 104 analyzes the image acquired by the image acquisition module 101 and detects an object in the image. If an object (hereinafter referred to as a second object) different from the first object is detected in the image in which the first object is detected, the operation acceptance module 104 accepts an operation corresponding to a positional relationship between the first object and the second object.

In the storage 103, information in which the operation corresponding to the positional relationship between the first object and the second object is predetermined (hereinafter referred to as operation information) is preliminarily stored besides the object pattern.

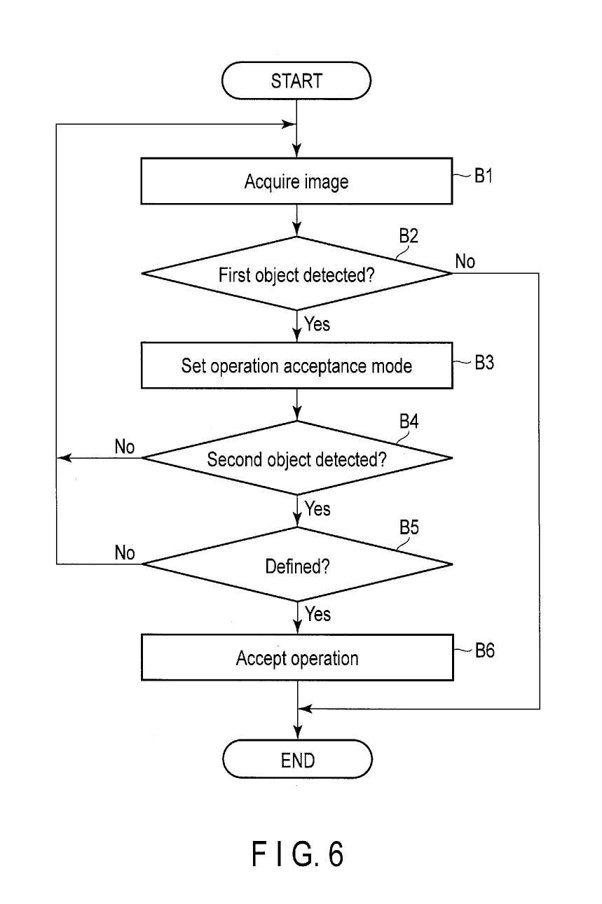

Next, a processing procedure of the electronic apparatus 10 of the present embodiment will be explained with reference to a flowchart of FIG. 6.

If the user uses the electronic apparatus 10, the user turns on the power of the electronic apparatus 10 by, for example, pressing the power button. The electronic apparatus 10 is thereby activated and the OS is executed by the processor 11c. The OS is designed based on the input operation using the mouse or the touchpad as explained above and, in this case, for example, a screen in which an icon, a cursor (pointer) and the like are arranged is assumed to be displayed on the display 11a.

Next, to execute an operation on the electronic apparatus 10, the user wearing the electronic apparatus 10 turns on the power of the camera 11b. The camera 11b thereby starts capturing an image including objects existing in the direction of the user's line of sight. The power of the camera 11b may be turned on at any time while the user wears the electronic apparatus 10 (i.e., while the electronic apparatus 10 is activated).

In this case, the image acquisition module 101 sequentially acquires images (i.e., a plurality of still images composing a moving image) captured by the camera 11b (block B1).

The mode setting module 102 executes processing of detecting the first object in the images acquired in block B1 (hereinafter referred to as target images), based on the object pattern stored in the storage 103.

The first object is assumed to be, for example, the user's one hand (for example, left hand) in an extended status. In this case, the object pattern defining the information on human hands is stored in the storage 103 and, if an object (area) matching the object pattern is present in the target images, the mode setting module 102 can detect the user's one hand (first object) in the target images. In contrast, if an object matching the object pattern is not present in the target images, the user's one hand is not detected in the target images.

Next, it is determined whether the first object is detected in the target images or not (block B2).

If it is determined that the first object is detected in the target images (YES in block B2), the mode setting module 102 sets (shifts) the electronic apparatus 10 in the operation acceptance mode (i.e., an input mode of the user interface for the eyeglasses-type wearable device) (block B3).

If the electronic apparatus 10 is set in the operation acceptance mode in block B3, the operation acceptance module 104 executes processing of detecting the second object in the target images, based on the object pattern stored in the storage 103.

The second object is assumed to be a hand (for example, a right hand) opposite to the user's one hand detected as the first object. In this case, if the object (area) matching the object pattern stored in the storage 103 (i.e., the object pattern defining the information on the human hands) is present in the target images, the operation acceptance module 104 can detect (positions of) user's fingers in the target images. In contrast, if an object matching the object pattern is not present in the target images, the user's fingers are not detected in the target images.

Next, it is determined whether the second object is detected in the target images or not (block B4).

If it is determined that the second object is detected in the target images (YES in block B4), the operation acceptance module 104 determines whether the operation corresponding to the positional relationship between the first object and the second object in the target images is defined or not, based on the operation information stored in the storage 103 (block B5).

If it is determined that the operation corresponding to the positional relationship between the first object and the second object in the target images is defined (YES in block B5), the operation acceptance module 104 accepts the operation (block B6).

If the operation is accepted in block B6, the operation acceptance module 104 issues an instruction to the electronic apparatus 10 according to the operation. The processing corresponding to the instruction issued by the operation acceptance module 104 is thereby executed in the electronic apparatus 10.

In contrast, if it is determined that the first object is not detected (NO in block B2), the processing shown in FIG. 6 is ended. In this case, the electronic apparatus 10 is not set in the operation acceptance mode (i.e., the normal operation mode is maintained).

In addition, if it is determined in block B4 that the second object is not detected (NO in block B4) and if it is determined in block B5 that the operation corresponding to the positional relationship between the first object and the second object in the target images is not defined (NO in block B5), for example, the processing returns to block B1 and is repeated while the electronic apparatus 10 is set in the operation acceptance mode. If it is determined in block B2 that the first object is not detected in a state in which the electronic apparatus 10 is set in the operation acceptance mode, setting of the operation acceptance mode of the electronic apparatus 10 is canceled. In other words, in the present embodiment, the setting of the operation acceptance mode is assumed to be maintained while the first object is detected (i.e., while the images including the first object are captured by the camera 11b).

A specific example of the operation accepted by the operation acceptance module 104 in the present embodiment will be hereinafter explained.

In the present embodiment, it is assumed that the screen configured to be operated with the general-purpose mouse or touchpad is displayed on the display 11a as explained above, i.e., that the OS designed based on the operation using the mouse or the touchpad is executed but, the electronic apparatus 10 of the present embodiment is not configured to include the mouse or the touchpad since the electronic apparatus 10 is an eyeglasses-type wearable device.

For this reason, in the present embodiment, by, for example, moving the user's own hand (first object) in front of the camera 11b (a position which the user can visually recognize), the camera 11b captures images including the palm and the user performs an action of sliding a finger of the other hand (second object) on the palm. In this case, the electronic apparatus 10 of the present embodiment can accept the operation corresponding to a positional relationship between the palm and the finger in the user's action.

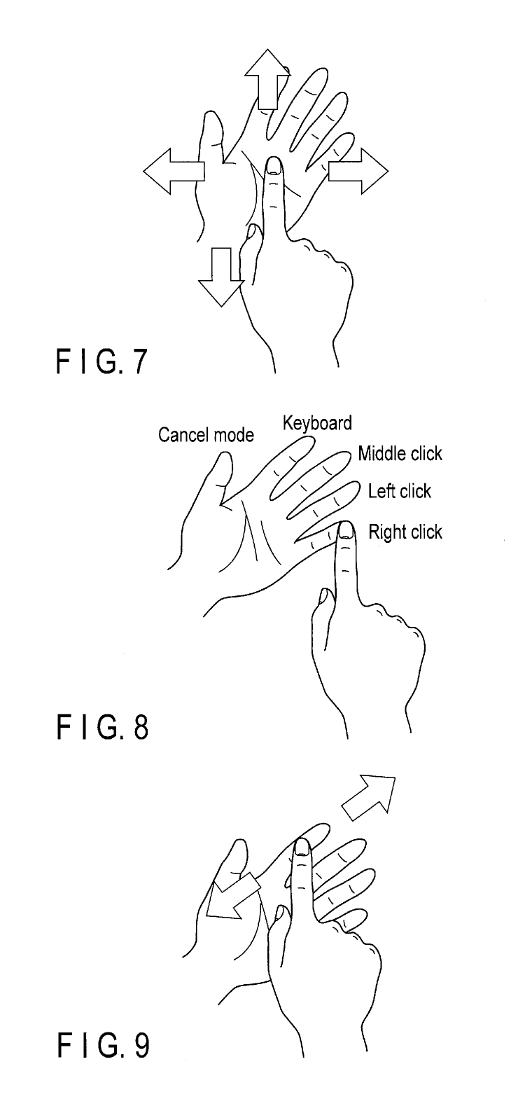

More specifically, as shown in FIG. 7, if a user's action of sliding an index finger on the palm is detected, the electronic apparatus 10 (operation acceptance module 104) accepts an operation of moving the cursor on the screen displayed on the display 11a (hereinafter referred to as a cursor moving operation). According to this, the user can execute an operation to the electronic apparatus 10 by regarding the user's palm as the touchpad and can move the cursor in accordance with the finger movement (amount) on the palm. The movement (amount) of the finger on the palm can be detected from a plurality of images in time series acquired in block B1 shown in FIG. 6.

In addition, the movement direction of the cursor does not depend on the orientation of the user's palm, but is determined based on, for example, the direction of the finger's movement to the axis of the camera 11b (i.e., the direction of the finger's movement on the images captured by the camera 11b).

Acceptance of the cursor movement operation as, for example, the above-mentioned position input operation at the electronic apparatus 10 has been explained, but the electronic apparatus 10 can also accept an operation (decision input operation) other than the cursor moving operation.

As shown in FIG. 8, for example, if approach of a finger of the right hand (for example, an index finger) to (a tip of) a little finger of the user's left hand in an extended state (i.e., a positional relationship of the index finger of the user's right hand overlapping the little finger of the left hand) is detected, an operation similar to the right-click operation on the mouse is accepted. In this case, an instruction that the right click on the mouse has been executed is issued by the operation acceptance module 104 and the processing corresponding to the instruction is executed in the electronic apparatus 10.

In addition, for example, if approach of a finger of the right hand to (a tip of) a ring finger of the user's left hand is detected, an operation similar to the left-click operation on the mouse is accepted. In this case, an instruction that the right click on the mouse has been executed is issued by the operation acceptance module 104 and the processing corresponding to the instruction is executed in the electronic apparatus 10.

In addition, for example, if approach of a finger of the right hand to (a tip of) a middle finger of the user's left hand is detected, an operation similar to the middle-click (wheel click) operation on the mouse is accepted. In this case, an instruction that the middle click on the mouse has been executed is issued by the operation acceptance module 104 and the processing corresponding to the instruction is executed in the electronic apparatus 10.

In addition, for example, if approach of a finger of the right hand to (a tip of) an index finger of the user's left hand is detected, an operation similar to an operation of pressing (a predetermined key of) a keyboard is accepted. In this case, an instruction that the predetermined key on the keyboard has been pressed is issued by the operation acceptance module 104 and the processing corresponding to the instruction is executed in the electronic apparatus 10.

Furthermore, for example, if approach of a finger of the right hand to (a tip of) a thumb of the user's left hand is detected, an operation of canceling the setting of the operation acceptance mode is accepted. In this case, an instruction that the setting of the operation acceptance mode has been canceled is issued by the operation acceptance module 104 and the processing corresponding to the instruction (i.e., cancellation of the setting of the operation acceptance mode) is executed in the electronic apparatus 10. If the user's left hand is not detected in the images captured by the camera 11b in the above-explained manners, the setting of the operation acceptance mode may be canceled.

Thus, in the present embodiment, for example, different operations (a plurality of operations) can be accepted in accordance with the type of the finger of the user's left hand with which the finger of the user's right hand is detected to approach. Each of the above-explained operations is assumed to be defined in the operation information stored in the storage 103. The electronic apparatus 10 can accept the operations (such as the decision input operation) corresponding to the positional relationship between (the fingers of) the user's hands by using the operation information. The operations are accepted according to the approach between the fingers in the above explanations, but may be accepted according to the contact between the fingers. In this case, for example, deformation or the like of the finger of the left hand is considered if the finger of the right hand is made to contact the finger of the left hand, and presence/absence of the contact can be determined by detecting the deformation in the images. As regards an example of deformation of the finger of the left hand in a case where the finger of the right hand is made to contact the finger of the left hand, for example, the finger of the left hand is considered to be deformed in a direction of moving away from the finger of the right hand or a portion of contact with the finger of the right hand and the surrounding are considered to be depressed on a surface of the finger of the left hand.

Each of the above-explained operations is a mere example, and the operation corresponding to the type of the finger of the user's left hand may be an operation other than the above-explained operations (for example, an operation of scrolling the screen or the like). For example, the operation of scrolling the screen (wheel operation) may be defined as the operation corresponding to, for example, the index finger of the user's index finger. In this case, as shown in FIG. 9, by sliding the finger of the user's right hand toward the tip of the index finger of the left hand and in the opposite direction, an operation of rotating the wheel in a forward direction and an operation of rotating the wheel in an opposite direction may be accepted.

In addition, different functions can be assigned to the respective fingers of the user's left hand. According to this, if the approach (or touch) of the finger of the right hand to the finger of the user's left hand is detected, the function assigned to the finger of the left hand (for example, activation of a predetermined application program or the like) can be executed.

As explained above, in the present embodiment, the image including the first object and the second object captured by the camera 11b is acquired, and the operation corresponding to the positional relationship between the first object and the second object including in the acquired image is accepted.

In the present embodiment, in this configuration, for example, the operation on the electronic apparatus 10 such as an eyeglasses-type wearable device can be accepted with a good accuracy by the user's simple operation.

More specifically, the first object includes the user's one hand, the second object includes a finger of the user's other hand, movement of the finger of the other hand on the palm of the hand included in the acquired image is detected, and the cursor on the screen displayed on the display 11a is moved in response to the detected movement. In the present embodiment having such a configuration, the user can regard the own palm as a touchpad and execute the operation similar to the operation to the touchpad, to the electronic apparatus 10. Furthermore, in the present embodiment, for example, since an explicit target, which is the palm, is present for sliding the finger, the user can intuitively recognize the positions of the finger (i.e., the sliding distance of the finger) or the like.

In addition, if the approach of a finger of user's one hand (i.e., the first finger) to a finger of the user's other hand (i.e., the second finger) is detected, an instruction to the electronic apparatus 10 in response to the operation corresponding to the type of the finger of the user's one hand is issued by the operation acceptance module 104. In the present embodiment having such a configuration, the user, touching any one of fingers of the left hand with, for example, the finger (the index finger or the like) of the right hand, can execute a plurality of operations corresponding to the touched finger, to the electronic apparatus 10.

In addition, in the present embodiment, since the action of sliding the finger on the palm (i.e., the position input operation for the electronic apparatus 10) and the action of allowing the finger of the right hand to touch (the tip of) any one of the fingers (i.e., the decision input operation for the electronic apparatus 10) can be clearly distinguished from each other, an error in accepting the position input operation or the decision input operation can be avoided. Each of the above-explained actions has an advantage that misunderstanding resulting from pointing at a surrounding person does not occur since an object other than the user's own palm and finger does not need to be pointed at.

Furthermore, in the present embodiment, the electronic apparatus 10 is set in the operation acceptance mode if the first object (i.e., the user's palm) is detected in the acquired image, and the cursor is moved and the instruction to the electronic apparatus 10 is issued if the electronic apparatus 10 is set in the operation acceptance mode. In the present embodiment having such a configuration, the electronic apparatus 10 can avoid the action which is not intended by the user.

In the present invention, the second object has been explained as the finger of the user's other hand, but may be, for example, an object such as a pen. According to this, the user can move the cursor on the screen by performing an action such as sliding the pen on the palm of the left hand.

The first object has been explained as the user's one hand, but may be a plate-like object such as a card or a notebook. In other words, for example, even if the first object is a card and the second object is a pen, the cursor can be moved in the electronic apparatus 10 by sliding the pen on the card. Furthermore, for example, by arranging a plurality of different marks on a card and touching (pointing) any one of the marks with the pen, the instruction corresponding to the type of mark can also be issued.

In the present embodiment, the electronic apparatus body 11 is equipped with the display 11a (i.e., the small monitor), but the display 11a may be supported by the lens portion in the eyeglasses shape of the electronic apparatus 10 (eyeglasses-type wearable device).

A projection module may be provided on the electronic apparatus body 11 instead of the display 11a. More specifically, by urging the projection module to project a screen (image) on the display supported by the lens portion in the eyeglasses shape of the electronic apparatus 10 (eyeglasses-type wearable device), the user may be able to visually recognize the screen.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a camera configured to capture an image;
a hardware processor connected to the camera; and
a display configured to display a cursor in a screen, wherein
the hardware processor is configured to:
acquire the image captured by the camera, the image including user's one hand and an object different from the user's one hand,
detect movement of the object on the user's one hand in the acquired image, and
move the cursor in response to the detected movement.

2. The electronic apparatus of claim 1, wherein
the hardware processor is further configured to:
set the electronic apparatus in an operation acceptance mode if the user's one hand is detected in the acquired image, and
move the cursor if the movement of the object is detected in a state in which the electronic apparatus is set in the operation acceptance mode.

3. The electronic apparatus of claim 2, wherein
the object in the image is a finger of the user's other hand.

4. The electronic apparatus of claim 2, wherein the hardware processor comprises:
means for acquiring the image captured by the camera, the image including user's one hand and an object different from user's one hand,
means for detecting movement of the object on the user's one hand, and
means for moving the cursor in response to the detected movement.

5. An electronic apparatus, comprising:
a camera configured to capture an image;
a hardware processor connected to the camera; and
a display configured to display a screen,
the hardware processor is configured to:
acquire the image captured by the camera, the image including user's one hand and the user's other hand,
if the electronic apparatus is set in an operation acceptance mode, detect contact or approach of a second finger of the user's other hand to a first finger of the user's one hand in the image, and
if the contact or approach of the second finger is detected, issuing an instruction to the electronic apparatus.

6. The electronic apparatus of claim 5, wherein
the instruction to the electronic apparatus includes at least one of designating a position on the screen, scrolling the screen, pressing a predetermined key of a keyboard and cancelling the operation acceptance mode.

7. The electronic apparatus of claim 6, wherein
the hardware processor is further configured to issue different instructions corresponding to a type of the first finger to which the contact or approach of the second finger is detected.

8. An electronic apparatus, comprising:
a camera configured to capture an image; and
a hardware processor connected to the camera,
the hardware processor is configured to:
acquire the image captured by the camera, the image including user's one hand and an object different from the user's one hand,
detect contact or approach of the object to a finger of the user's one hand in the acquired image, and
if the contact or approach of the object to the finger is detected, perform a function corresponding to a type of the finger.

9. The electronic apparatus of claim 8, wherein
the hardware processor is further configured to:
set the electronic apparatus in an operation acceptance mode if the one of the user's hands is detected in the acquired image, and
perform the function corresponding to the type of the finger if the contact or approach is detected in a state in which the electronic apparatus is set in the operation acceptance mode.

10. The electronic apparatus of claim 9, wherein
the object comprises a finger of the user's other hand.
